(19) United States
(12) Patent Application Publication
(10) Pub. No.: US 2014/0339283 A1
(43) Pub. Date: Nov. 20, 2014

(54) DEVICE FOR COMPENSATION OF SHEAF THICKNESS IN A STAPLER

(71) Applicant: Olle Strååt, Hestra (SE)

(72) Inventor: Olle Strååt, Hestra (SE)

(21) Appl. No.: 14/344,089

(22) PCT Filed: Aug. 21, 2012
(86) PCT No.: PCT/SE2012/000119

§ 371 Date: Mar. 11, 2014

(30) Foreign Application Priority Data
Sep. 13, 2011 (SE) 1100669-9

(51) Int. Cl. B27F 7/30

(52) U.S. Cl. CPC B27F 7/30
USPC 227/143

(57) ABSTRACT

A device (33) forming part of a drive arrangement (3) which itself forms part of a stapler (1), which arrangement moves an anvil (16) which forms part of the stapler and against which stapling of a workpiece (42¹; 42²), e.g. a sheaf of papers, is effected in a reciprocating stapling movement (P), such that in the forward movement (N) the anvil moves from an initial position to abut against the workpiece, which device compensates the drive arrangement's movement of the anvil in the forward direction (N) appropriately to the thickness of the workpiece, such that the device (33) can be moved between a locked state in which the anvil (16) is moved by the drive arrangement (3) and a unlocked state in which the drive arrangement does not move the anvil, because the device is put by an elastic means (25) into a locked state when the anvil is in an initial position, and the device in the forward movement (N) is kept in a locked state until the anvil has been brought into contact with the workpiece (42¹; 42²), after which the device is put into an unlocked state by a release mechanism (35) which is acted upon by the drive arrangement.

### TECHNICAL FIELD

The present invention relates to a device forming part of a drive arrangement which itself forms part of a stapler, which arrangement moves an anvil which forms part of the stapler and against which stapling of a workpiece, e.g. a sheaf of papers, is effected in a reciprocating stapling movement such that in the forward movement the anvil moves from an initial position to abut against the workpiece, which device compensates the drive arrangement's movement of the anvil in the forward direction appropriately to the thickness of the workpiece.

### STATE OF THE ART

Staplers with devices of the kind indicated are already known and, to cite but a few examples, are referred to in all essentials in EP 0636059, U.S. Pat. No. 6,626,348, U.S. Pat. No. 5,836,502, U.S. Pat. No. 5,791,548 and PCT/JP05/17359. However, these prior staplers have the disadvantage that their compensation of the anvil's movement is achieved by the device being elastically flexible and yielding appropriately to the thickness of the workpiece. As one skilled in the art will readily appreciate, this means not only that the amount of power consumed in overcoming the elastic flexibility increases with the thickness of the workpiece being stapled, but also that the drive arrangement has to be dimensioned to be able to exert the maximum force required to staple a workpiece of maximum thickness.

### PROBLEM

There is thus a need for a stapler which has a drive arrangement with a device for sheaf thickness compensation, such that the power required to compensate for sheaf thickness variation is independent of sheaf thickness, and which is so dimensioned that this power requirement is determined by that required for a sheaf of minimum thickness.

### SOLUTION

The present invention proposes a device which overcomes the above problem with a device of the kind indicated above which is characterized in that the device can be moved between a locked state in which the anvil is moved by the drive arrangement and an unlocked state in which the drive arrangement does not move the anvil in that the device is put by an elastic means into a locked state in which the anvil is in an initial position, and in that the device in the forward movement is kept in a locked state until the anvil has been brought into contact with the workpiece, whereafter the device is put into an unlocked state by a release mechanism which is acted upon by the drive arrangement.

The invention is further characterized in that the device takes the form of a toggle joint mechanism.

The invention is also characterized in that the elastic means takes the form of a coil spring.

The invention is further characterized in that the toggle joint mechanism comprises a first link connected to the anvil and a second link connected to the drive arrangement and that the second link is considerably longer than the first link.

The invention is also further characterized in that the release mechanism when not acted upon by the drive arrangement is kept in a state in which it does not act upon the toggle joint mechanism by an elastic means.

### BRIEF DESCRIPTION OF THE DRAWINGS

The invention is described below with reference to the attached drawings, in which

FIGS. 1-6 depict the stapler according to the present invention as seen from the side when stapling a workpiece of maximum thickness,

FIGS. 7-12 are drawings corresponding to FIGS. 1-6 but when stapling a workpiece of minimum thickness, and

FIGS. 13-16 are detail views of essential parts of the present invention depicted in various positions during a stapling movement.

### PREFERRED EMBODIMENT EXAMPLES

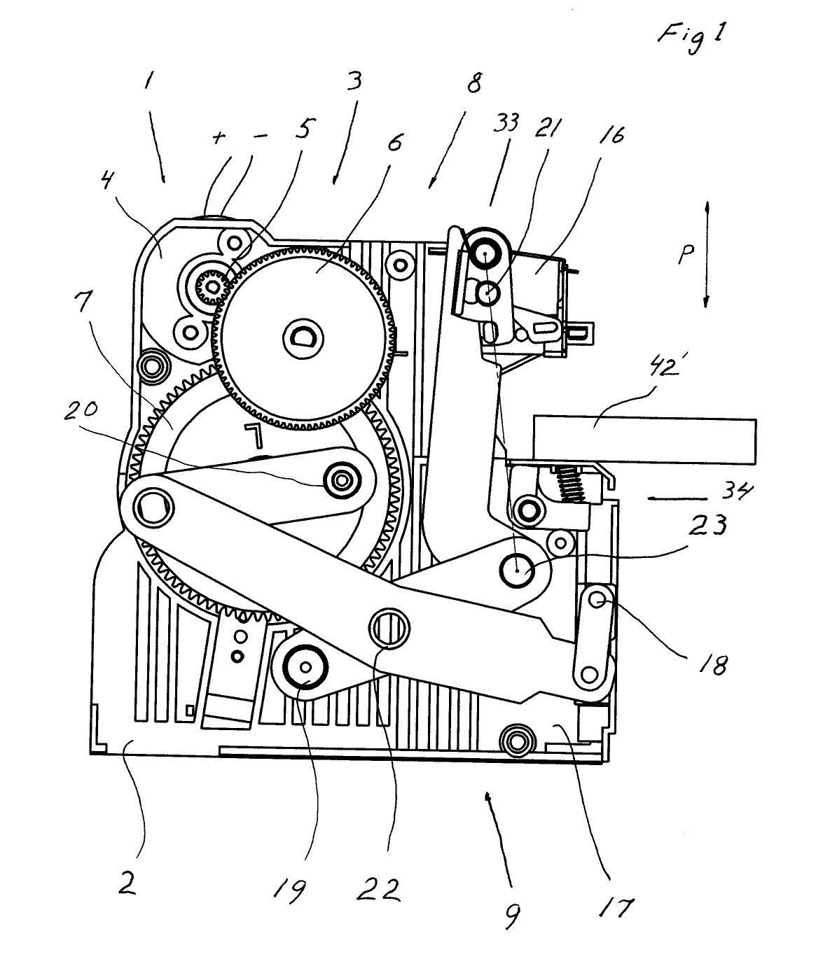

FIGS. 1-6 depict a stapler 1 provided with the invention according to the present patent application. They show the stapler comprising a frame 2 which has attached to it a drive arrangement 3 provided with a prime mover 4 which may preferably be powered electrically, gearwheels 5-7 connected to a gear arrangement 8, and a link arrangement 9 comprising a first link 10, a second link 11, a third link 12, a fourth link 13, a fifth link 14 and a sixth link 15. The frame also has an anvil 16 attached to it in a known way such that it can participate in a reciprocating stapling movement indicated by the double arrow P. The frame further has attached to it a staple magazine 17 containing staples which is only implied but will be obvious to one skilled in the art. The staple magazine has attached to it a driver 18, the only part depicted of which is that which is connected to the link arrangement 9. The driver can in a known way move up and down in the direction indicated by the double arrow P.

FIG. 1 shows the link arrangement 9 connected to the frame 2 by a first connecting spigot 19, to the gear arrangement 8 by a second connecting spigot 20, to the anvil 16 by a third connecting spigot 21 and to the driver by a connecting spigot which is an integral part of the driver 18. It also shows the links 11 and 12 connected together by a fourth connecting spigot 22. All of these connections are pivotable, a characteristic which may affect each of them in ways known to one skilled in the art. Their pivotability is preferably achieved by the connecting surfaces between the respective spigots and parts connected by them being sliding surfaces.

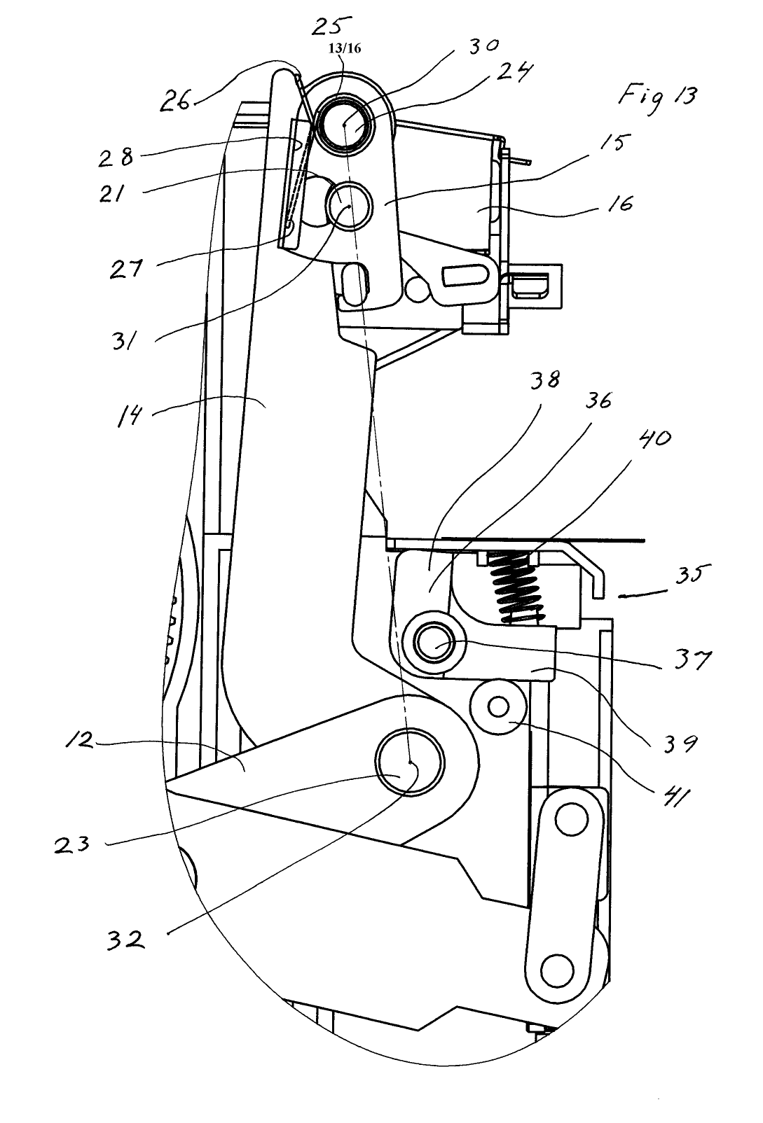

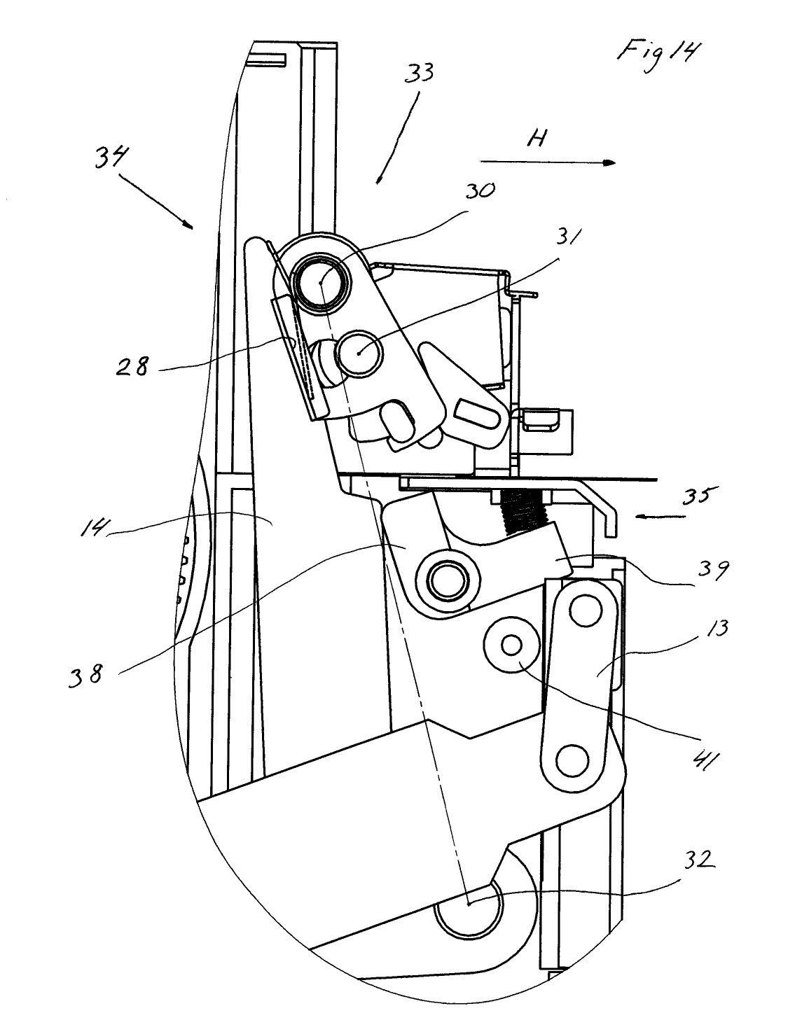

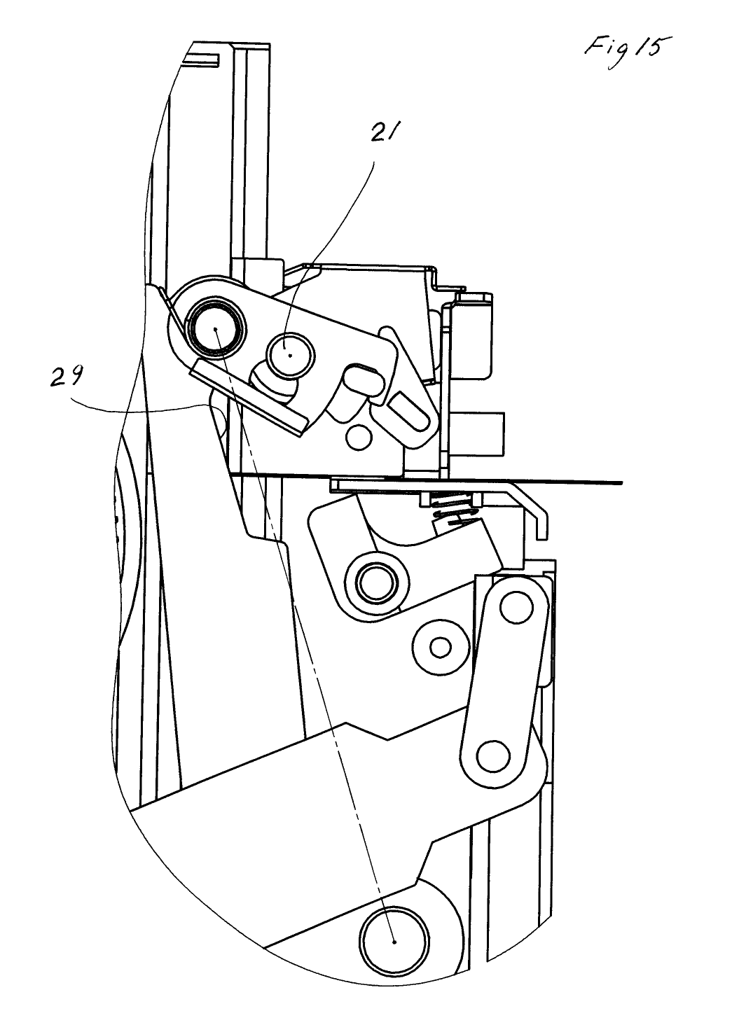

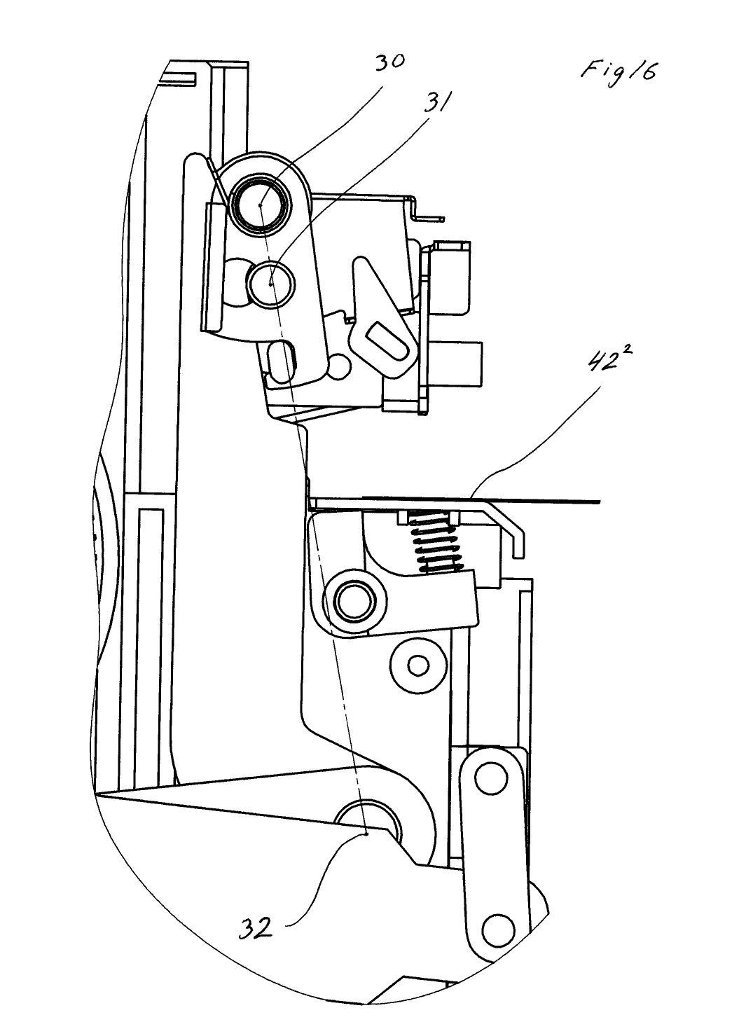

FIGS. 13-16 depict the links 14 and 15. As explained above, the link 15 is connected pivotably to the anvil 16, and the link 14 is connected to the link 12 by a first pivot pin 23. These drawings also show the links 14 and 15 connected together by a second pivot pin 24. They further show that a first elastic means in the form of a coil spring 25 is attached to the pin 24 and that the spring has a first limb 26 in contact with the link 14, and a second limb 27 in contact with a surface 28 pertaining to the link 15, as only depicted in FIGS. 13 and 14. The function of the spring 25 will be indicated by the description below. A stop surface 29 most clearly depicted in FIG. 15 is provided on the link 14 and is in contact with the spigot 21. The contact between the surface 29 and the spigot 21 is achieved by the spring 25 being tensioned and by its force between the pin 24, the surface 28 and the link 14 endeavouring to move the pin 24 in the direction indicated by the arrow H, see FIG. 14, thereby also causing the link 14 to move in the same direction but be brought to a halt when the stop surface 29 reaches contact with the spigot 21. As the stop surface is so situated relative to the link 14 that the movement in the direction H stops only when the centre 30 of the pin 24 has moved far enough in direction H for the centre 31 of the spigot 21 to have shifted to the left in FIG. 13 of the line A which connects the centre 30 of the pin 24 and the centre 32 of the pin 23, the spigot 21 and therefore the anvil 16 are caused to move downwards when the drive arrangement moves the pin 23 in the direction indicated by the arrow N, which is the direction of the stapling forward movement. The links 14 and 15, the pin 24 and the spring 25 thus constitute the device 33 according to the present invention and the device described above thus takes the form of a toggle joint mechanism 34 which in FIGS. 13 and 16 is depicted in a locked state in which it moves the anvil 16.

FIGS. 13 and 14 depict a release mechanism 35 provided with a rocker 36 which is connected pivotably to the frame 2 by a third pivot pin 37. The rocker comprises a third limb 38 and a fourth limb 39. A second elastic means in the form of a coil spring 40 is provided between the fourth limb 39 and the frame 2 to bring the fourth limb into contact with a stop 41 mounted on the frame 2. In FIG. 14 the fact that the fourth limb 39 is struck by the link 13 when the latter undergoes an upward movement, as will be explained below, has caused the rocker to move the link 14 in an opposite direction to the direction H, thereby moving the centre 31 of the spigot 21 to the right of the line A, with the result that the toggle joint mechanism assumes an unlocked state in which no movement of the anvil takes place. The fact that the link 14 is substantially longer than the link 15 means that the mechanism 35 need only effect a small movement of the link 14 for the toggle joint mechanism to assume an unlocked state.

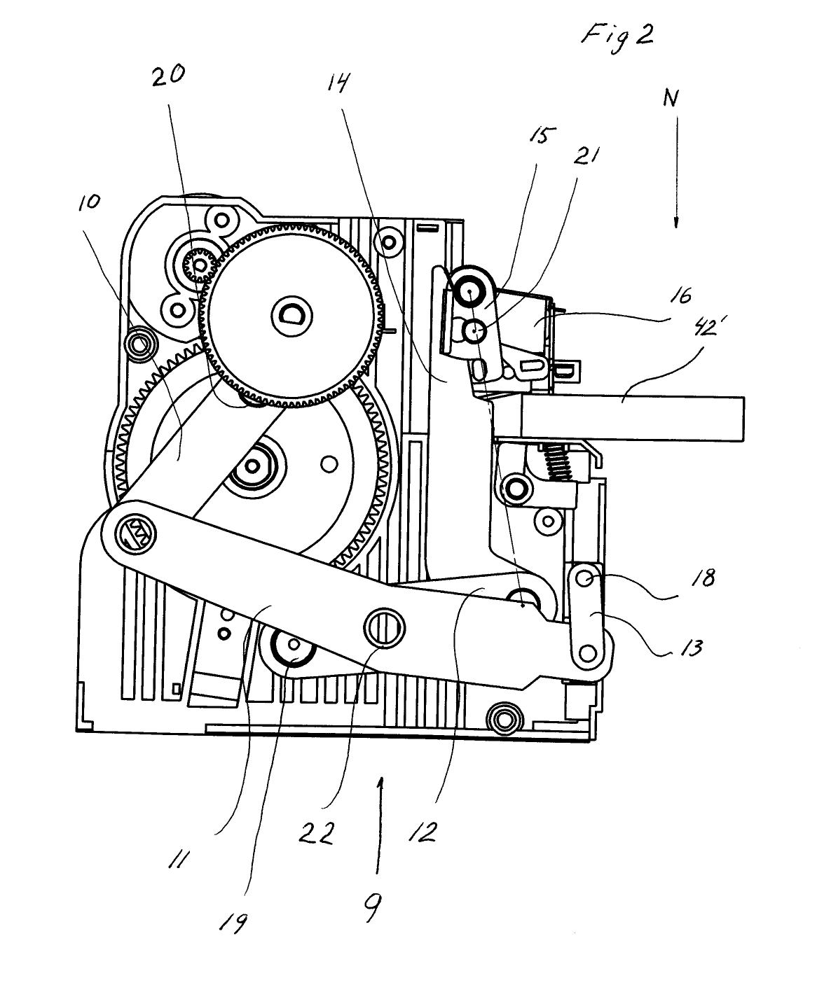

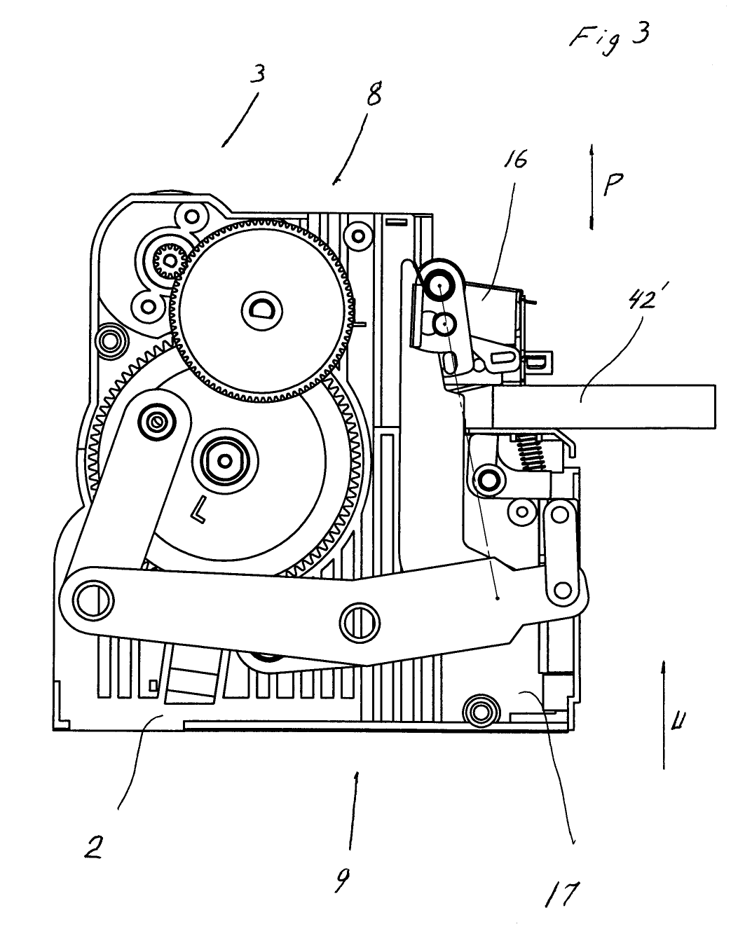

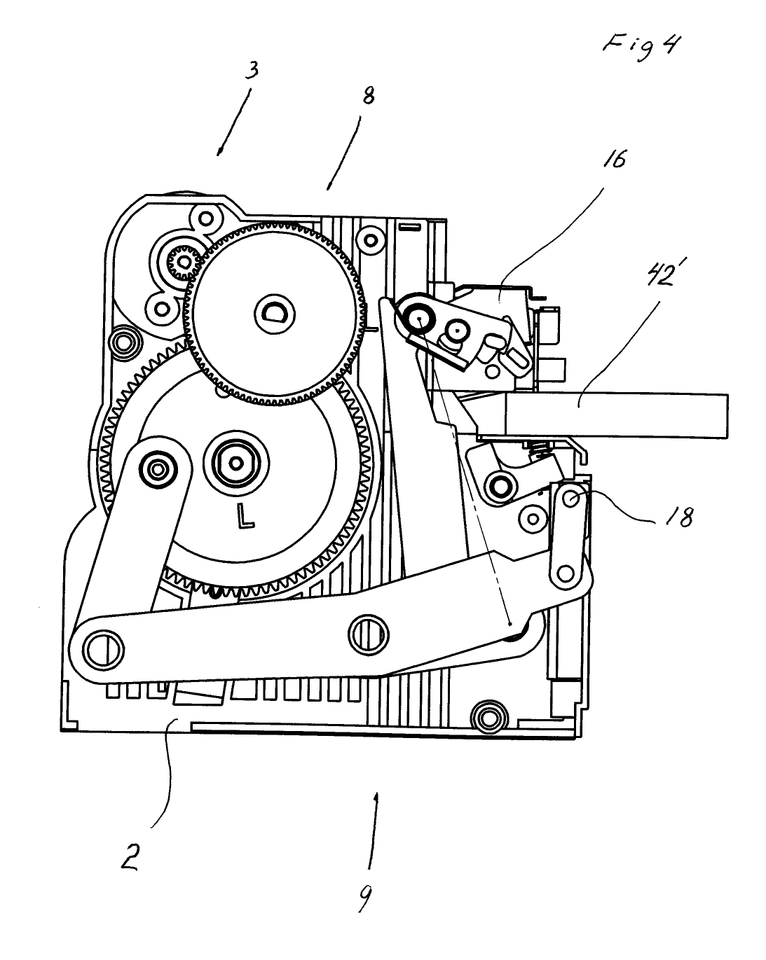

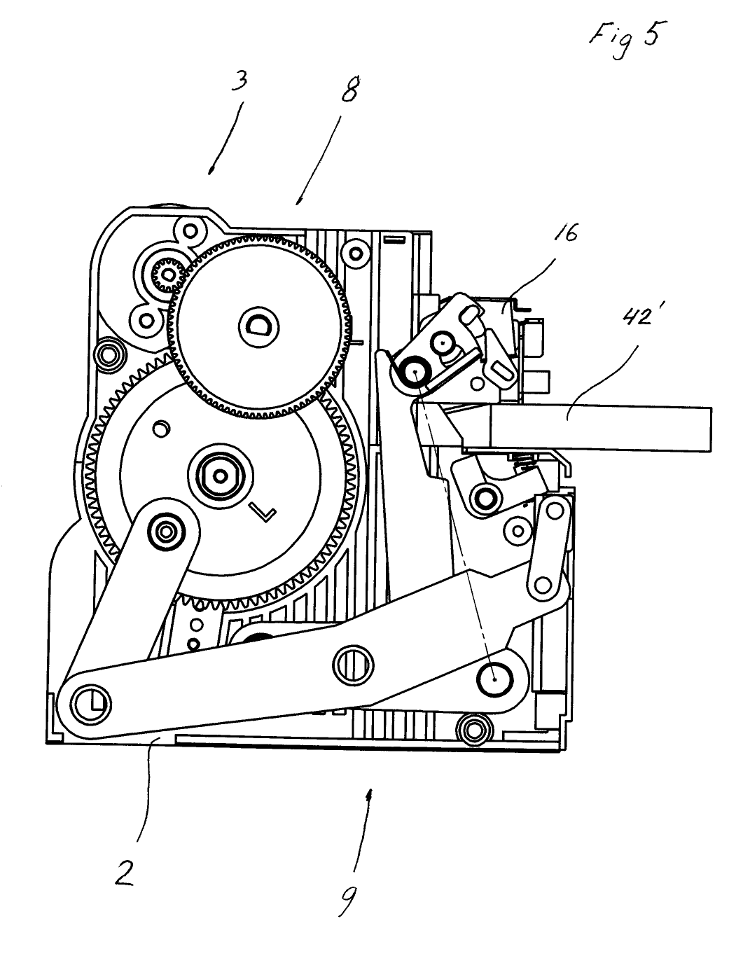

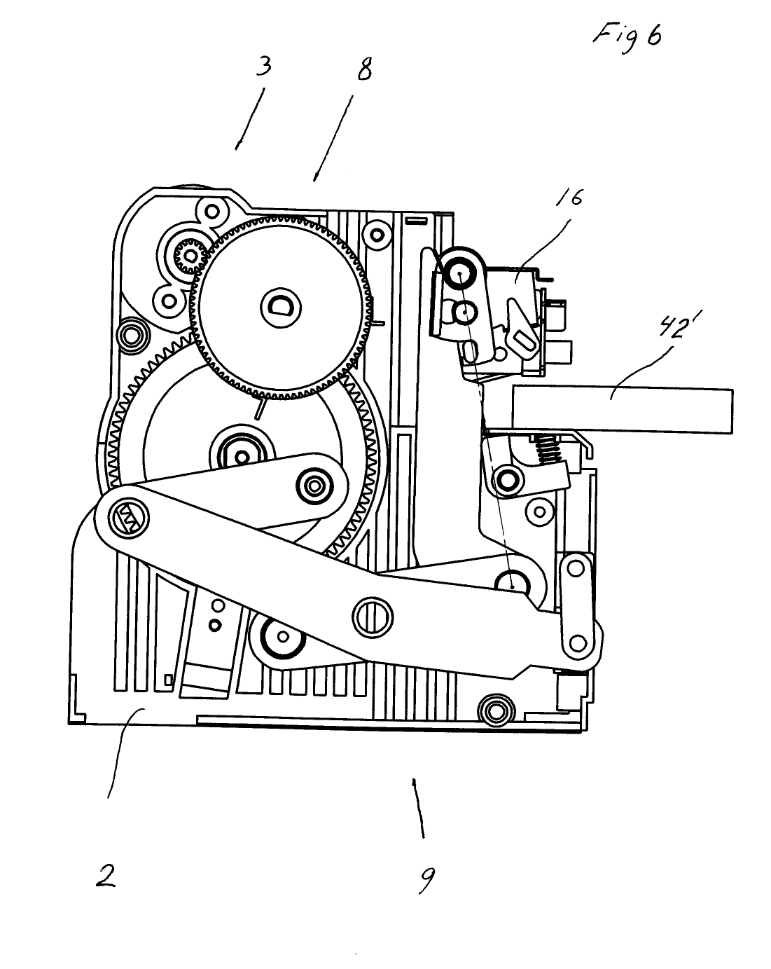

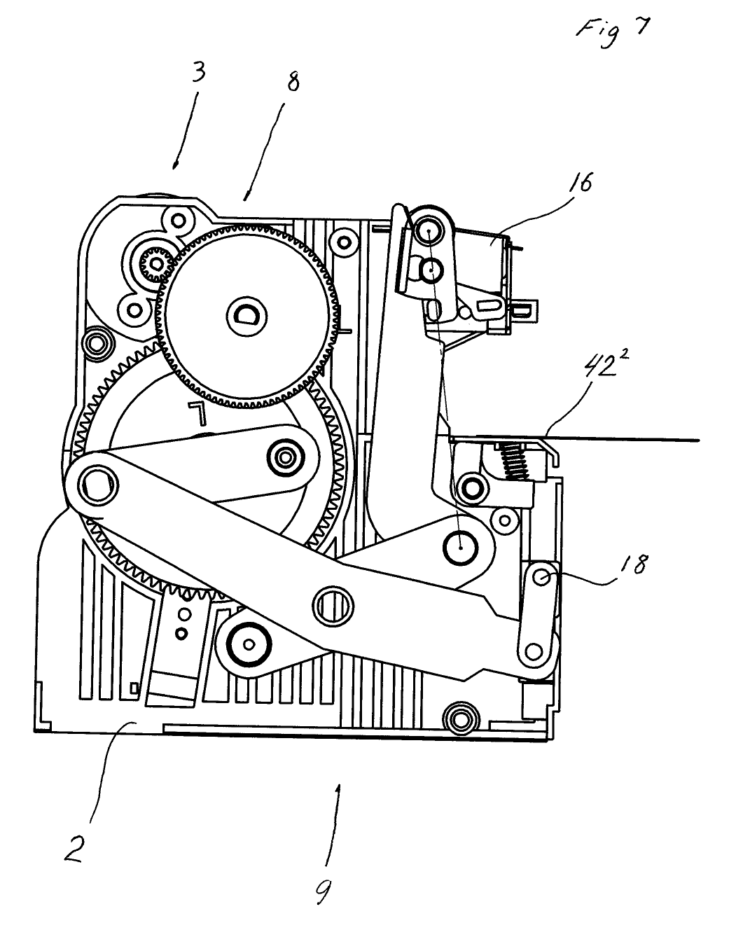

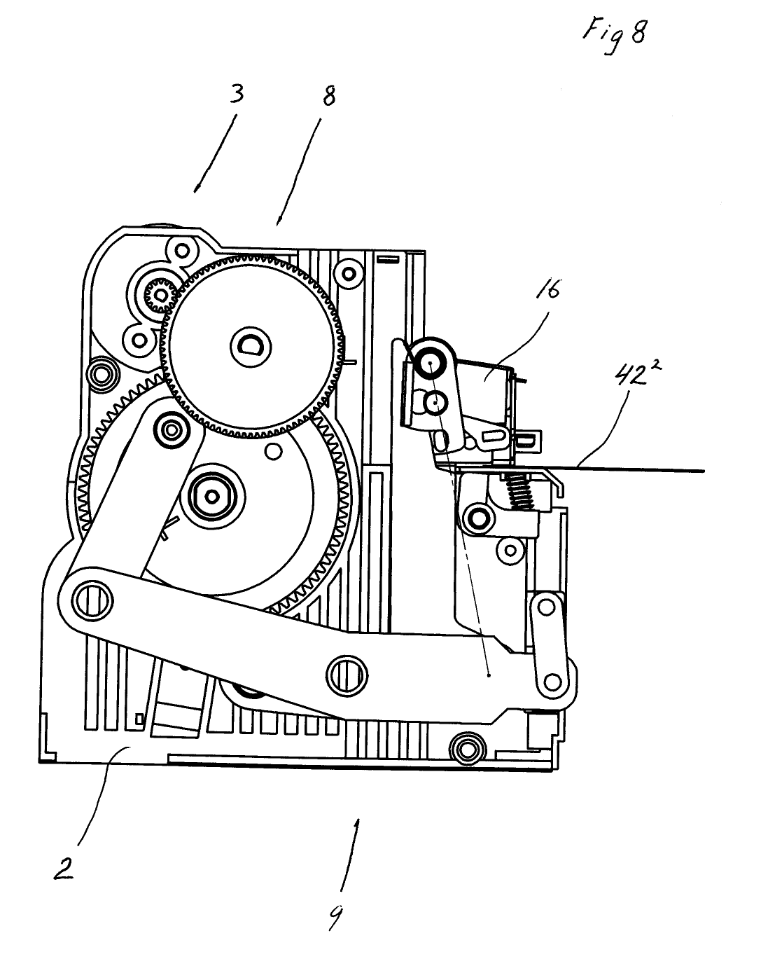

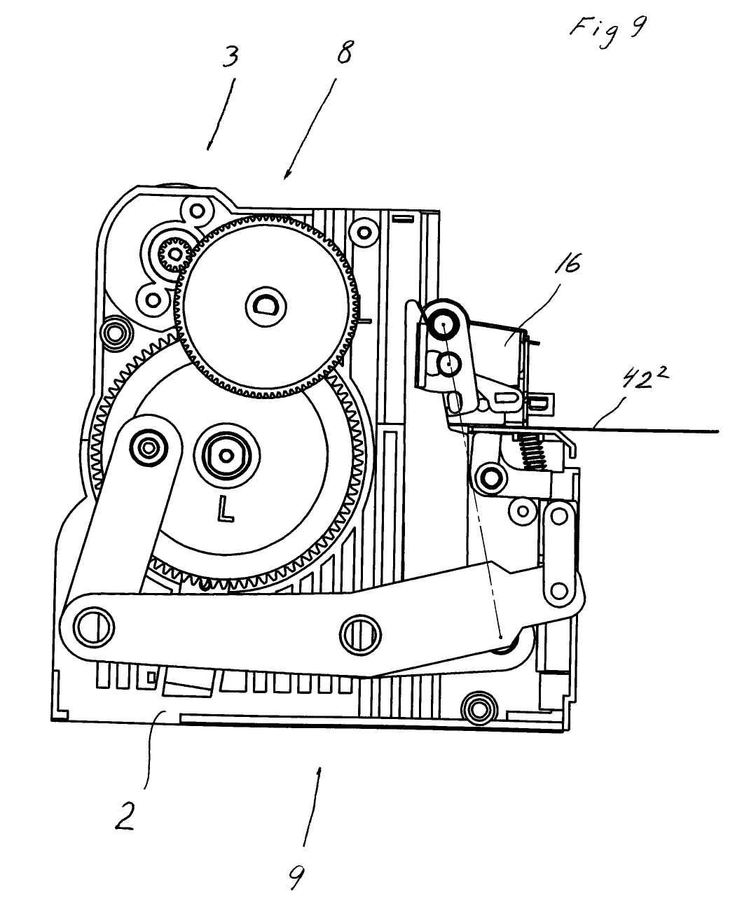

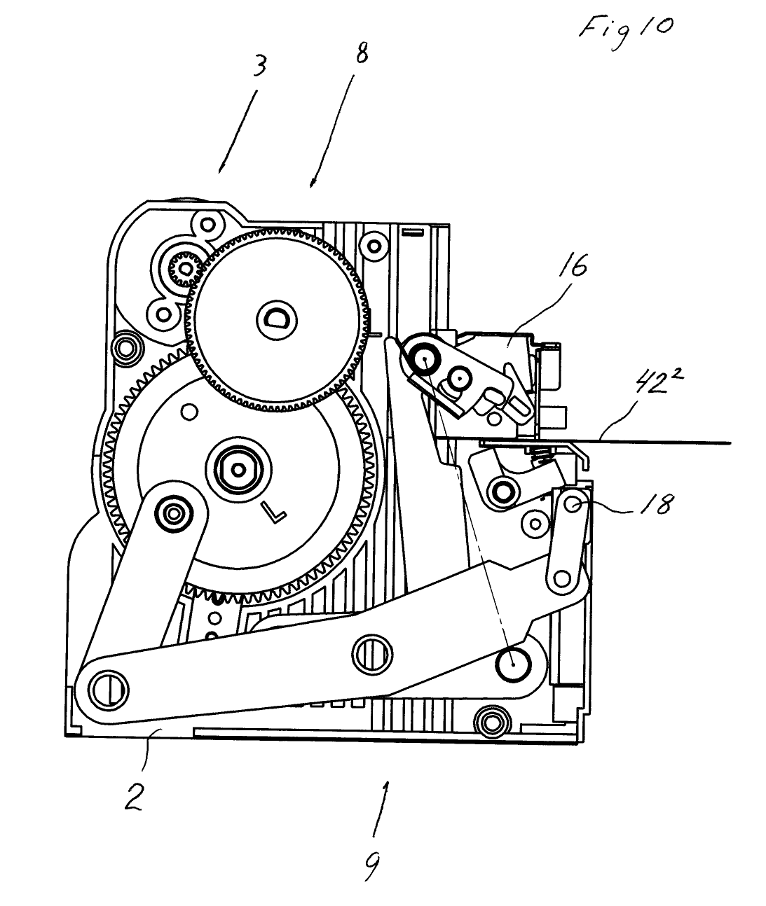

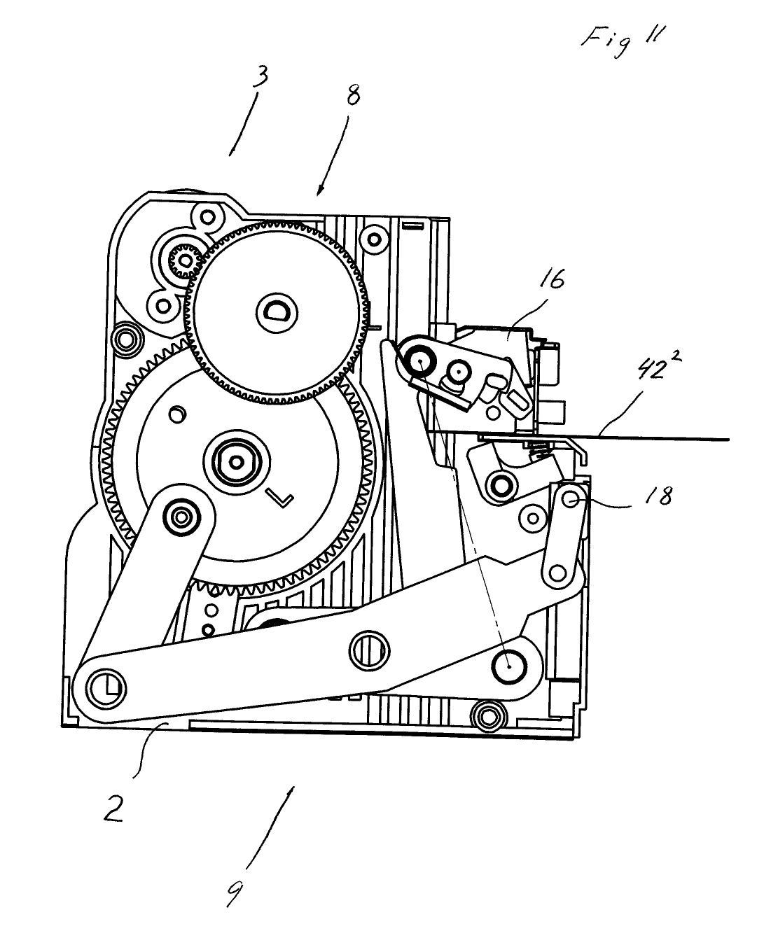

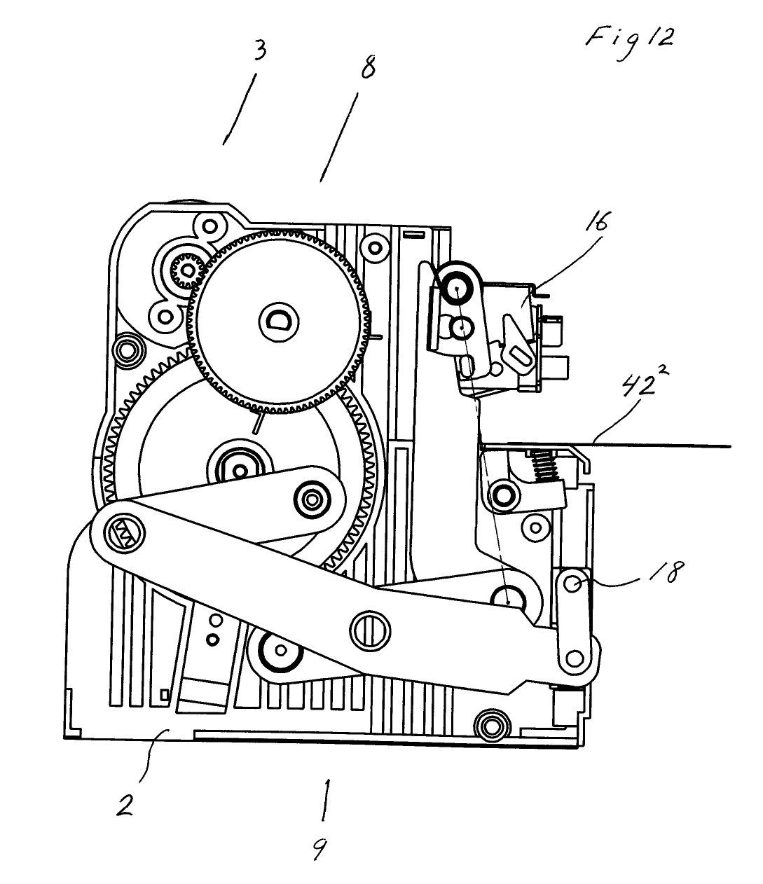

The function of the invention will now be described with reference to FIGS. 1-6 and 7-12. In FIGS. 1 and 7 the stapler is in an initial position. In FIG. 1 a workpiece 42¹ of maximum thickness is to be stapled and in FIG. 7 a workpiece 42² of minimum thickness is to be stapled. In FIGS. 2 and 8, with the device 33 in a locked state, the drive arrangement has moved the anvil 16 in the direction N to abut against the workpiece. In FIGS. 3 and 9 the drive arrangement has driven a staple into the workpiece by the driver 18 being moved in the direction indicated by the arrow U. This is not clear from the drawings but will be obvious to one skilled in the art. In FIGS. 4 and 10 the driver in its absolute final movement in the direction U has caused the rocker to move the link 14 in the direction and to the position in which the toggle joint mechanism is put into the unlocked state. In FIGS. 5 and 11, the drive arrangement has moved the link 14 further in the direction N. However, as the toggle joint mechanism is then in an unlocked state, no movement of the anvil takes place downwards and no force to move the link downwards is required beyond the minimum force generated by the further tensioning which occurs in the coil spring 25. However, this force is negligible and in all essentials independent of whether a thick or thin workpiece is being stapled. In FIGS. 6 and 12 the drive arrangement moves the anvil upwards until the anvil reaches the position depicted in FIGS. 1 and 7 and the toggle joint mechanism is put into a locked state.

1. A device forming part of a drive arrangement which itself forms part of a stapler, which arrangement moves an anvil which forms part of the stapler and against which stapling of a workpiece, e.g. a sheaf of papers, is effected in a reciprocating stapling movement such that in the forward movement the anvil moves from an initial position to abut against the workpiece, which device compensates the drive arrangement's movement of the anvil in the forward direction appropriately to the thickness of the workpiece, characterized in that the device can be moved between a locked state in which the anvil is moved by the drive arrangement and an unlocked state in which the drive arrangement does not move the anvil, in that the device is put by an elastic means into a locked state when the anvil is in an initial position, and in that the device in the forward movement is kept in a locked state until the anvil has been brought into contact with the workpiece, whereafter the device is put into an unlocked state by a release mechanism which is acted upon by the drive arrangement.

2. A device according to claim 1, characterized in that it takes the form of a toggle joint mechanism.

3. A device according to claim 1,
characterized in that the elastic means takes the form of a coil spring.

4. A device according to claim 2, characterized in that the toggle joint mechanism comprises a link connected to the anvil and a further link connected to the drive arrangement, and that the further link is considerably longer than the link.

5. A device according to claim 1, characterized in that the release mechanism, when not acted upon by the drive arrangement, is kept by a second elastic means in a state in which it does not act upon the toggle joint mechanism.

6. A device according to claim 2,
characterized in that the elastic means takes the form of a coil spring.

7. A device forming part of a drive arrangement which itself forms part of a stapler, which arrangement moves an anvil which forms part of the stapler and against which stapling of a workpiece, e.g. a sheaf of papers, is effected in a reciprocating stapling movement such that in the forward movement the anvil moves from an initial position to abut against the workpiece, which device compensates the drive arrangement's movement of the anvil in the forward direction appropriately to the thickness of the workpiece, characterized in that the device can be moved between a locked state in which the anvil is moved by the drive arrangement and an unlocked state in which the drive arrangement does not move the anvil, in that the device is put by an elastic component into a locked state when the anvil is in an initial position, and in that the device in the forward movement is kept in a locked state until the anvil has been brought into contact with the workpiece, whereafter the device is put into an unlocked state by a release mechanism which is acted upon by the drive arrangement.

8. A device according to claim 7, characterized in that it takes the form of a toggle joint mechanism.

9. A device according to claim 7,
characterized in that the elastic component includes a coil spring.

10. A device according to claim 9, characterized in that the toggle joint mechanism comprises a link connected to the anvil and a further link connected to the drive arrangement, and that the further link is considerably longer than the link.

11. A device according to claim 7, characterized in that the release mechanism, when not acted upon by the drive arrangement, is kept by a second elastic component in a state in which it does not act upon the toggle joint mechanism.

12. A device according to claim 8,
characterized in that the second elastic component includes a coil spring.
